(19) United States
(12) Patent Application Publication
(10) Pub. No.: US 2021/0331398 A1
(43) Pub. Date: Oct. 28, 2021

(54) VALVES FOR AIR FLOW CONTROL IN PRINTERS

(71) Applicant: HEWLETT-PACKARD DEVELOPMENT COMPANY, L.P., Spring, TX (US)

(72) Inventors: Michael Duda, Vancouver, WA (US); Justin M. Roman, Vancouver, WA (US); Luke P. Sosnowski, Vancouver, WA (US)

(21) Appl. No.: 16/608,490

(22) PCT Filed: Jul. 23, 2018
(86) PCT No.: PCT/US2018/043296

§ 371 Date: Oct. 25, 2019

(51) Int. Cl. B29C 64/364; G05B 19/18; B33Y 50/02; B33Y 30/00

(52) U.S. Cl. CPC B29C 64/364; G05B 19/182; G05B 2219/37375; B33Y 30/00; B33Y 50/02

(57) ABSTRACT

An example three-dimensional printer includes a humidity source, a build material reservoir, a conduit between the humidity source and the build material reservoir, an air source to transfer air from the humidity source through the conduit towards the build material reservoir, and a valve assembly connected to the conduit to control a flow of the air in the conduit while the printer enters an inactive mode of operation. The air source is to remain in an active mode of operation. The air source is controlled to transmit the air in the conduit until the air in the conduit adjacent to the build material reservoir reaches a temperature and relative humidity threshold.

### BACKGROUND

Printing devices, such as three-dimensional (3D) printers contain several components used in the additive manufacturing process. Build material typically flows from 3D printers in a selected manner to create a 3D build. The flowability of the build material may be controlled.

### BRIEF DESCRIPTION OF THE DRAWINGS

The following detailed description references the drawings, in which:

FIG. 1 is a block diagram illustrating a system to control the flow of air in a conduit of a printer using an air-actuated valve, according to an example.

FIG. 2 is a block diagram illustrating the printer of FIG. 1 arranged as a 3D printer, according to an example.

FIG. 3 is a block diagram illustrating the valve of the printer of FIG. 1 arranged as a uni-directional passive valve that is air-actuated, according to an example.

FIG. 4 is a block diagram illustrating the system of FIG. 1 incorporating a sensor to measure temperature and relative humidity, according to an example.

FIG. 5 is a block diagram illustrating the processor of the printer of FIG. 1 switching an air blower to enter into an inactive mode of operation to terminate the flow of air in the printer, according to an example.

FIG. 6A is a block diagram illustrating closing the valve of the printer of FIG. 1 by terminating the flow of air in the printer, according to an example.

FIG. 6B is a block diagram illustrating utilizing a flowmeter and switch to control the closing of the valve of the printer of FIG. 1, according to an example.

FIG. 7 is a block diagram illustrating a 3D printer using a valve assembly to control the flow of air through a conduit in the 3D printer, according to an example.

FIG. 8A is a schematic diagram illustrating a rigid body first frame and first opening of the valve assembly of the 3D printer of FIG. 7, according to an example.

FIG. 8B is a schematic diagram illustrating a rigid body second frame and second opening of the valve assembly of the 3D printer of FIG. 7, according to an example.

FIG. 8C is a cross-sectional schematic diagram illustrating a deformable valve and third opening of the valve assembly of the 3D printer of FIG. 7, according to an example.

FIG. 8D is a schematic diagram illustrating a base and flap of a deformable valve of the valve assembly of the 3D printer of FIG. 7, according to an example.

FIG. 8E is a cross-sectional schematic diagram illustrating the valve assembly controlling the flow of air in a conduit of the 3D printer of FIG. 7, according to an example.

FIG. 9A is a schematic diagram illustrating a first side of the valve assembly of the 3D printer of FIG. 7, according to an example.

FIG. 9B is a schematic diagram illustrating a second side of the valve assembly of the 3D printer of FIG. 7, according to an example.

FIG. 10A is a cross-sectional schematic diagram illustrating the flap of the deformable valve of FIG. 9 in an open position to permit the flow of air in a conduit of a 3D printer, according to an example.

FIG. 10B is a cross-sectional schematic diagram illustrating the flap of the deformable valve of FIG. 9 in an open position with dry air to flow in the conduit of a 3D printer, according to an example.

FIG. 100 is a cross-sectional schematic diagram illustrating the flap of the deformable valve of FIG. 9 in a closed position to prevent the flow of air in a conduit of a 3D printer, according to an example.

FIG. 11 is a block diagram illustrating a system to control the flow of air in a printer using computer-executable instructions, according to an example.

FIG. 12 is a flow diagram illustrating a process of controlling the flow of air in a printer, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Active humidification control may be used as an effective technique for improving build material flow properties and reducing triboelectric charging of such build material. In examples, the build material may include powders, granular compositions, thermoplastic pellets, resins, or polymers, ceramics, metals, among other materials. One side effect of humidification is that upon printer shutdown, areas of high humidity may remain in portions of the pneumatic transport lines and moist air can continue to diffuse out of the humidifier. This can lead to problems like corrosion and sensor drift. In a worst-case scenario this can result in the formation of condensation causing component failure. Corrosion prevention is typically accomplished by using corrosion resistant materials, which tend to be more expensive than non-corrosion resistant materials.

A 3D printer may generate humid air to improve the flow of build material. A 3D printer may include sensors used to monitor the humidity levels in pneumatic transport lines in a 3D printer. However, when the 3D printer shuts off after use, the humidity level may rise in the transport lines, which can cause the build material to clump or otherwise become degraded. Additionally, other components, such as the sensors, may experience damage due to increased condensation. In order to address this, the examples described below provide a passive valve, such as a flapper valve, diaphragm valve, umbrella valve, etc. used to control the humidity levels in a 3D printer. Accordingly, the examples provided use a firmware process to control the flow of air through the conduit by issuing a command to have the water heater enter into the inactive mode of operation. Next, the firmware process instructs air blowers in the printer to continue to blow air through the conduit. Once the air reaches the valve, the valve opens permitting the air to continue through the conduit reaching the container where the build material is retained. The firmware process instructs the sensors to monitor the relative humidity and temperature near the container in order to calculate a dewpoint reading. Once the dewpoint reaches an acceptable level, the firmware process turns off the air blowers and all remaining systems of the printer. Upon turning off the air blowers, the air no longer flows in the conduit thereby returning the valve to its closed position, which retains the area of the conduit near the container with a dry; e.g., below a predetermined humidity level or environment. Accordingly, the examples provided use a combination of one-way valve and a system drying process to isolate humidity sources in a printer and protect vulnerable areas/components from sitting in a high humidity environment for prolonged periods of time.

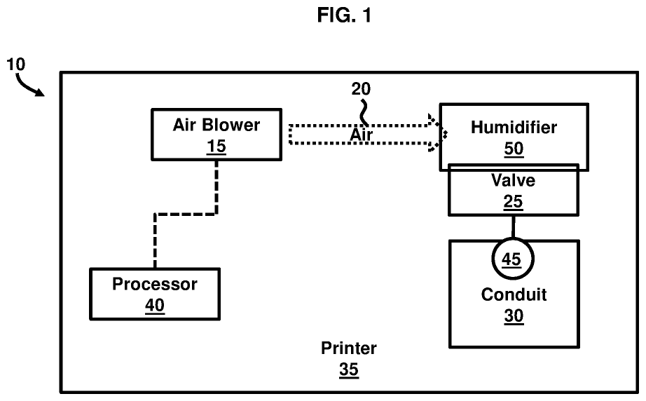

FIG. 1 illustrates a system 10 comprising an air blower 15 to provide a flow of air 20. In an example, the air blower 15 may comprise a fan, an exhaust system, a vacuum pump, or any other type of device capable of providing a flow of air 20. In accordance with various examples, the flow of air 20 may include any temperature of air and may be ambient air drawn from an outside source; i.e., from outside the system 10. In an example, the flow of air 20 may be between approximately 20-40° C., although other temperatures and temperature ranges are possible. The flow of air 20 may comprise any composition of air, according to an example. Furthermore, the flow of air 20 may have any suitable flow rate, which may be controlled by the air blower 15, in an example. Moreover, the flow rate of the flow of air 20 may be a constant flow rate or a variable flow rate.

The system 10 also comprises a valve 25 to control the flow of air 20 through a conduit 30 of a printer 35. The air blower 15 may be positioned at any suitable location along the conduit 30 or at any other suitable location in the printer 35. The valve 25 may be any suitable type of valve 25 such as a mechanical valve, electrical valve, electro-mechanical valve, electro-magnetic valve, optic valve, pneumatic valve, or any other type of pressure valve, according to some examples. The valve 25 may be positioned adjacent to the conduit 30 or in the conduit 30. In an example, the valve 25 may be sandwiched between adjacent portions of the conduit 30 in a slip fit arrangement. Moreover, the conduit 30 may be any type of channel, tube, pipe, pneumatic transport lines, etc. arranged to permit the flow of air 20 to travel therein. The conduit 30 may comprise any suitable shape, length, or configuration, and may be one continuous conduit 30 or a series of interconnected components making up the entire conduit 30. Additionally, the conduit 30 may either be completely disposed within the printer 35 or may be partially disposed within the printer 35. Furthermore, the conduit 30 may connect to multiple terminals, regions, and/or components in the printer 35 utilizing the flow of air 20 to provide an air source to perform any number of various functions. For example, the flow of air 20 may be used to cool heated components in the printer 35, etc. In an example, the printer 35 may comprise any type of printer, such as a 3D printer.

The system 10 also includes a processor 40 to maintain the flow of air 20 through the conduit 30 while the printer 35 enters an inactive mode of operation. The air blower 15 is to remain in an active mode of operation. Additionally, the processor 40 may also remain in an active mode of operation in an example. In this regard, according to an example, the inactive mode of operation may refer to the various components and sub-systems in the printer 35 that typically draw power or receive a signal to perform a function are no longer in an active state to perform their intended function(s). For example, the inactive mode of operation may be a sleep mode, hibernating mode, standby mode, low power mode, or other mode of operation in which the operating state of the component or sub-system is interrupted, inactivated, or otherwise discontinued. Conversely, the active mode of operation allows the active components and sub-systems to continue to operate in their typical and intended modes.

In some examples, the processor 40 described herein and/or illustrated in the figures may be embodied as hardware-enabled modules and may be configured as a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that are configured with electronic circuits process computer logic instructions capable of providing digital and/or analog signals for performing various functions as described herein.

In some examples, the processor 40 may comprise a central processing unit (CPU) of the printer 35. In other examples the processor 40 may be a discrete component independent of other processing components in the system 10. In other examples, the processor 40 may be a microprocessor, microcontroller, hardware engine, hardware pipeline, and/or other hardware-enabled device suitable for receiving, processing, operating, and performing various functions for the printer 35. The processor 40 may be provided in the printer 35, coupled to the printer 35, or communicatively linked to the printer 35 from a remote networked location, according to various examples.

The flow of air 20 provided by the air blower 15 is to open the valve 25. For example, the air blower 15 may comprise a sufficient flow rate capable of triggering actuation of the valve 25 causing the valve 25 to open, and to remain open until the flow rate of the flow of air 20 falls below a threshold to actuate or otherwise open the valve 25. In an example, the flow of air 20 triggers actuation of the valve 25; i.e., no other signal or stimulus is used to open and/or close the valve 25. In other examples, the flow of air 20 along with other types of signals or stimuli are used in various combinations to actuate the valve 25. For example, the processor 40 or another device may transmit a signal to the valve 25 to actuate the valve.

The processor 40 is provided to calculate a dewpoint in a region 45 of the conduit 30 adjacent to a humidifier 50. The dewpoint may be calculated by receiving temperature and humidity readings from sensing devices in the region 45 of the conduit 30 adjacent to the humidifier 50, and determining the dewpoint using standard dewpoint calculation techniques. In an example, the humidifier 50 may be any type of component or device that humidifies water. For example, the humidifier 50 may humidify water held in a water tank used to mix with build material used by the printer 35. In an example, the water may be between approximately 70-80° C. when humidified by the humidifier 50. The level of humidity provided by the humidifier 50 may be fixed or may be variable. Additionally, the humidity may become reduced upon the water being cooled. The processor 40 is also provided to discontinue the flow of air 20 from the air blower 15 upon determining that the calculated dewpoint satisfies a threshold dewpoint level. In an example, the threshold dewpoint level may be approximately 25° C. According to an example, it may take approximately 30 minutes for the threshold dewpoint level to be achieved before the flow of air 20 is discontinued, although this timing may be dependent on the configuration of the conduit 30, the initial temperature and relative humidity in the region 45 of the conduit 30 adjacent to the humidifier 50, among other factors.

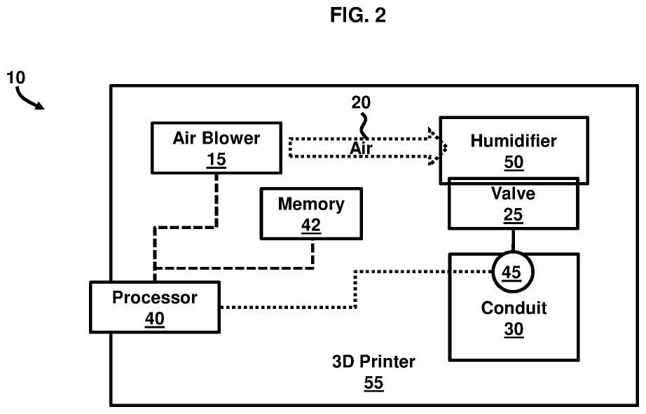

FIG. 2, with reference to FIG. 1, illustrates an example where the printer 35 comprises a 3D printer 55. In examples, the 3D printer 55 may comprise any type of 3D printing device and may be part of a system of 3D printing devices communicatively linked together. In an example, the processor 40 may compare the calculated dewpoint from the region 45 of the conduit 30 adjacent to the humidifier 50 to a previously-stored threshold dewpoint level, which may be stored in memory 42, as shown in FIG. 2. Accordingly, once the calculated dewpoint reaches or otherwise satisfies the threshold dewpoint level, the processor 40 may transmit a signal to the air blower 15 to discontinue the flow of air 20 in the conduit 30. As such, the 3D printer 55 may be programmed with the threshold dewpoint level set for the region 45 of the conduit adjacent to the humidifier 50, in an example. Moreover, the processor 40 of the 3D printer 55 may receive updates; i.e., through firmware updates, etc. that may change the threshold dewpoint level for the region 45.

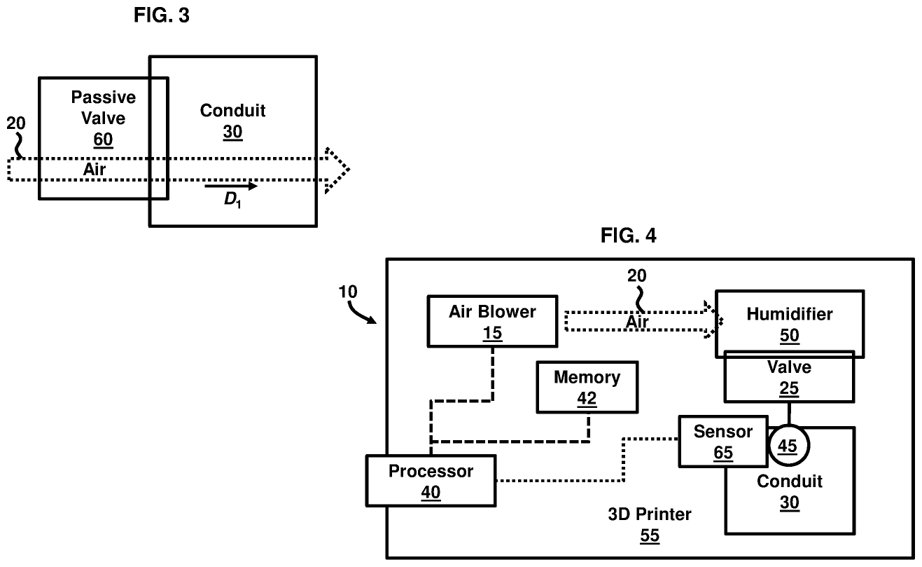

FIG. 3, with reference to FIGS. 1 and 2, illustrates that the valve 25 comprises a uni-directional passive valve 60 such as a flapper valve, diaphragm valve, umbrella valve, etc., according to some examples. In this regard, the valve 60 does not use any electrical, magnetic, and/or optical stimulus for actuation. Rather, the flow of air 20 is used to actuate the valve 60, according to this example. Furthermore, the valve 60 may be set to actuate into an open configuration in one direction such that the uni-directional mode allows for the flow of air 20 to move along a single direction D₁ in the conduit 30 thereby preventing the flow of air 20 to reverse directions in the conduit 30.

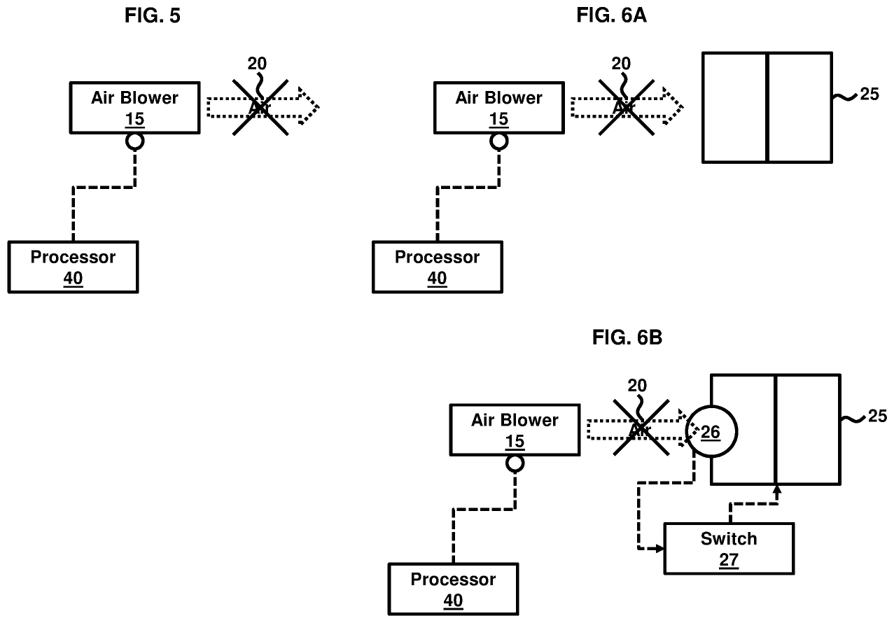

FIG. 4, with reference to FIGS. 1 through 3, illustrates that the system 10 comprises a sensor 65 to measure a temperature and relative humidity in the region 45 of the conduit 30 adjacent to the humidifier 50. The processor 40 is to calculate the dewpoint based on the temperature and relative humidity measured by the sensor 65. The sensor 65 is communicatively linked to the processor 40 to allow the processor 40 to receive the temperature and relative humidity measurements from the sensor 65. In examples, the sensor 65 may be wirelessly connected to the processor 40 or may be operatively connected through a wired connection such that the sensor 65 may send signals to the processor 40 to transmit the temperature and relative humidity measurements. In an example, the sensor 65 may comprise a thermometer to measure the temperature and any of a psychrometer and a hygrometer to measure the relative humidity in the region 45 of the conduit 30 adjacent to the humidifier 50. In an example, the region 45 of the conduit may be immediately adjacent to the humidifier 50.

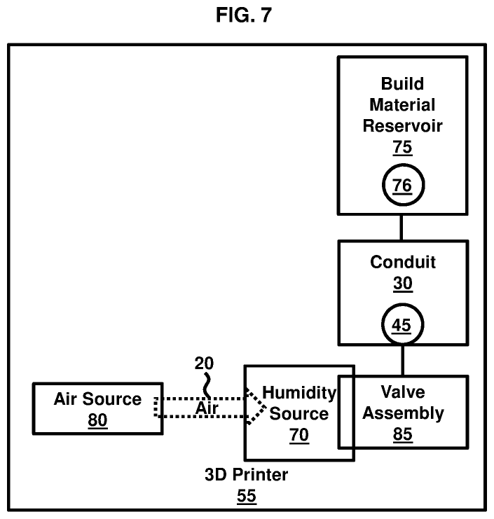

FIG. 5, with reference to FIGS. 1 through 4, illustrates that the processor 40 is to control the air blower 15 to enter into an inactive mode of operation upon discontinuing the flow of air 20. As described above, once the calculated dewpoint reaches or otherwise satisfies the threshold dewpoint level, the processor 40 may transmit a signal to the air blower 15 to discontinue the flow of air 20 in the conduit 30. This signal also controls the air blower 15 to enter into the inactive mode of operation. Accordingly, the discontinuing of the flow of air 20 results in the air blower 15 entering the inactive mode of operation, and alternatively, the switching of the air blower 15 to the inactive mode of operation causes the flow of air 20 to discontinue, according to some examples.

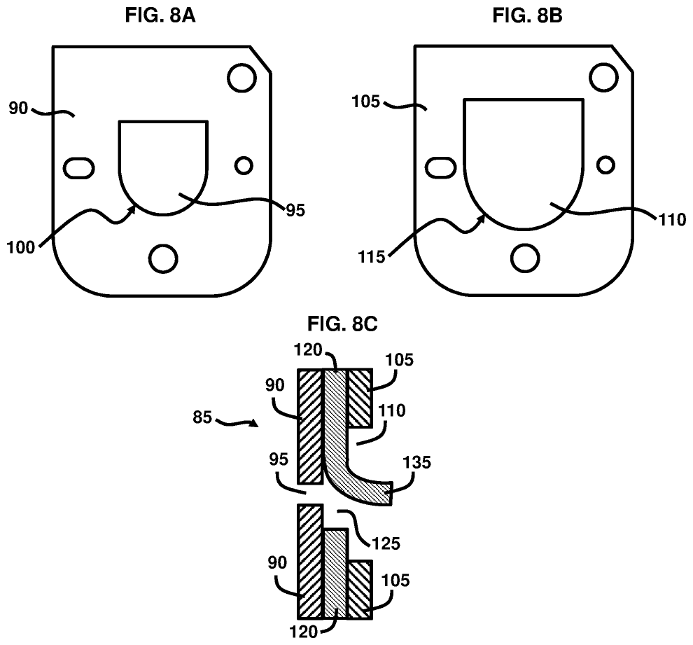

FIG. 6A, with reference to FIGS. 1 through 5, illustrates that a discontinuing of the flow of air 20 from the air blower 15 causes the valve 25 to close. In an example, the actuation of the valve 25 may be controlled by the flow of air 20, and once the flow of air 20 in the conduit 30 stops, the valve 25 is no longer actuated in its open position, thereby causing the valve 25 to close. An example of this is where the valve 25 is a uni-directional passive valve 60 in which the valve 60 utilizes no other actuating force other than the flow of air 20 to articulate the valve 60 from a closed-to-open position, and vice versa. In another example, the valve 25 may comprise a flowmeter or pressure sensor 26, as shown in FIG. 6B, with reference to FIGS. 1 through 6A, to detect the flow of air 20, and upon the discontinuing of the flow of air 20 from the air blower 15, flowmeter or pressure sensor 26 sends a signal to a switch 27 of the valve 25 to cause the valve 25 to close.

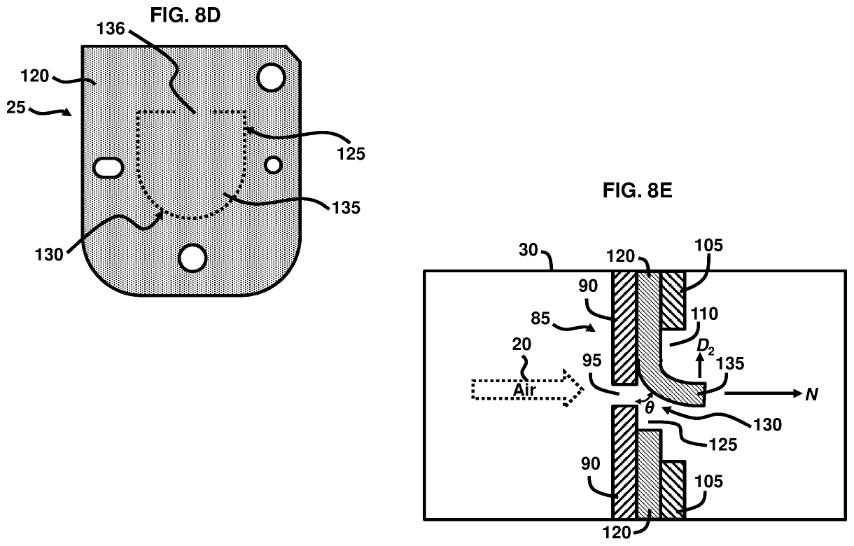

FIG. 7, with reference to FIGS. 1 through 6B, illustrates a 3D printer 55 comprising a humidity source 70. In an example, the humidity source 70 may be any type of component or device that humidifies air. The 3D printer 55 also includes a build material reservoir 75 to hold build material 76, which may be used by the 3D printer 55 to perform additive manufacturing. For example, the humidity source 70 may humidify air with water held in a water tank used to mix with the build material 76 used by the 3D printer 55. The level of humidity provided by the humidity source 70 may be fixed or may be variable. Additionally, the humidity may become reduced upon the water being cooled. Moreover, the flow rate of the build material 76 may be controlled by the level of humidity provided by the humidity source 70.

The 3D printer 55 further includes a conduit 30 between the humidity source 70 and the build material reservoir 75, and an air source 80 to transfer air 20 from the humidity source 70 through the conduit 30 towards the build material reservoir 75. The conduit 30 may be any type of channel, tube, pipe, pneumatic transport lines, etc. arranged to permit the air 20 to travel therein. The conduit 30 may comprise any suitable shape, length, or configuration, and may be one continuous conduit 30 or a series of interconnected components making up the entire conduit 30. Additionally, the conduit 30 may either be completely disposed within the 3D printer 55 or may be partially disposed within the 3D printer 55. Furthermore, the conduit 30 may connect to multiple terminals, regions, and/or components in the 3D printer 55 utilizing the air 20 to perform any number of various functions. The air source 80 may comprise a blower, fan, an exhaust system, a vacuum pump, or any other type of device capable of providing the air 20 to move within the conduit 30. In accordance with various examples, the air 20 may include any temperature of air and may be ambient air drawn from an outside source; i.e., from outside the 3D printer 55. In an example, the air 20 may be between approximately 20-40° C. The air 20 may comprise any composition of air, according to an example. Furthermore, the air 20 may travel at any suitable flow rate, which may be controlled by the air source 80, in an example. Moreover, the flow rate of the air 20 may be a constant flow rate or a variable flow rate. Additionally, the air source 80 may be positioned at any suitable location along the conduit 30 or at any other suitable location in the 3D printer 55, according to various examples.

Furthermore, the 3D printer 55 includes a valve assembly 85 connected to the conduit 30 to control a flow of the air 20 in the conduit 30 while the 3D printer 55 enters an inactive mode of operation. The air source 80 remains in an active mode of operation. The valve assembly 85 may be any suitable type of valve assembly 85 such as a mechanical valve assembly, electrical valve assembly, electro-mechanical valve assembly, electro-magnetic valve assembly, optic valve assembly, pneumatic valve assembly, or any other type of pressure valve assembly, according to some examples. The valve assembly 85 may be positioned adjacent to the conduit 30 or in the conduit 30. In an example, the valve assembly 85 may be sandwiched between adjacent portions of the conduit 30 in a slip fit arrangement. According to some examples, the valve assembly 85 may be a single component or a multiple component device.

The air source 80 is controlled to transmit the air 20 in the conduit 30 until the air 20 in the conduit 30 adjacent to the build material reservoir 75 reaches a temperature and relative humidity threshold. In this regard, the air source 80 continues to transmit the air 20 in the conduit so long as the temperature and relative humidity in the conduit 30 adjacent to the build material reservoir 75 is below the threshold. Once, the threshold has been reached, the air source 80 turns off and discontinues to transmit the air 20. The air source 80 may be controlled by processors, microcontrollers, etc., in conjunction with sensing devices to sense the temperature and relative humidity, according to various examples.

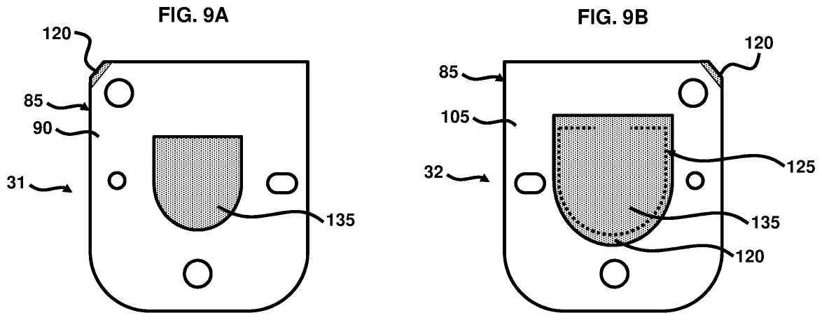

According to an example, FIG. 8A, with reference to FIGS. 1 through 7, illustrates that the valve assembly 85 comprises a rigid body first frame 90 comprising a first opening 95 having a first size 100. The rigid body first frame 90 may be any suitable size, shape, thickness, or configuration. The rigid body first frame 90 may be made of any suitable non-permeable material having sufficient strength characteristics to withstand elevated temperatures and humidity levels. In an example, the rigid body first frame 90 may comprise polyamide-imide, polyetheretherketone, or polyetherimide, or composites thereof. The first opening 95, which extends through an entire thickness of the rigid body first frame 90, may comprise any suitable shape and the first size 100 may be appropriately dimensioned in any suitable size in order to maintain the structural integrity of the rigid body first frame 90 in consideration of the first opening 95.

The example of FIG. 8B, with reference to FIGS. 1 through 8A, illustrates that the valve assembly 85 also comprises a rigid body second frame 105 comprising a second opening 110 having a second size 115 larger than the first size 100. The rigid body second frame 105 may be any suitable size, shape, thickness, or configuration. The rigid body second frame 105 may be made of any suitable non-permeable material having sufficient strength characteristics to withstand elevated temperatures and humidity levels. In an example, the rigid body second frame 105 may comprise the same material as the rigid body first frame 90. In an example, the rigid body second frame 105 may comprise polyamide-imide, polyetheretherketone, or polyetherimide, or composites thereof. In another example, the rigid body second frame 105 may comprise a different material than the rigid body first frame 90. The second opening 110, which extends through an entire thickness of the rigid body second frame 105, may comprise any suitable shape and the second size 115 may be appropriately dimensioned in any suitable size, so long it is larger than the first size 100 of the first opening 95 of the rigid body first frame 90, in order to maintain the structural integrity of the rigid body second frame 105 in consideration of the second opening 110.

The example of FIG. 8C, with reference to FIGS. 1 through 8B, illustrates that the valve assembly 85 further comprises a deformable valve 25 positioned between the rigid body first frame 90 and the rigid body second frame 105. The deformable valve 25 may be any suitable size, shape, thickness, or configuration. The deformable valve 25 may be made of any suitable non-permeable material having sufficient strength characteristics to withstand elevated temperatures and humidity levels. In an example, the deformable valve 25 may comprise the same material as the rigid body first frame 90 and the rigid body second frame 105. In an example, the deformable valve 25 may comprise polyamide-imide, polyetheretherketone, or polyetherimide, or composites thereof. In another example, deformable valve 25 may comprise a different material than the rigid body first frame 90 and the rigid body second frame 105.

FIG. 8D, with reference to FIGS. 1 through 8C, illustrates an example in which the deformable valve 25 comprises a base 120 comprising a third opening 125 having a third size 130 larger than the first size 100 and smaller than the second size 115. The third opening 125, which extends through an entire thickness of the base 120, may comprise any suitable shape and the third size 130 may be appropriately dimensioned in any suitable size, so long it is larger than the first size 100 of the first opening 95 of the rigid body first frame 90 and smaller than the second size 115 of the second opening 110 of the rigid body second frame 105, in order to maintain the structural integrity of the base 120 in consideration of the third opening 125. The deformable valve 25 also includes a flap 135 extending from the base 120 and comprising the third size 130. The flap 135 may comprise a flexible, non-permeable material and thickness that is the same as the base 120 or different from the base 120. Moreover, the flap 135 may be defined by a cut in the base 120 as provided by the third opening 125. In order for the flap 135 to be connected to the base 120, a portion 136 of the flap is adjoined to the base 120.

In an example shown in FIG. 8E, with reference to FIGS. 8A through 8D, the first opening 95, the second opening 110, and the third opening 125 are positioned normal N to the flow of air 20 in the conduit 30. This positioning permits the flap 135 to outwardly extend in a direction D₂ substantially the same as the flow of the air 20 through the conduit 30. When the flow of the air 20 terminates, then the flap 135, which covers the third opening 125 of the base 120, is positioned generally orthogonal to the direction D. The flow rate of the air 20 along with the material properties such as the material stiffness, thickness, material type, etc. determine the angle θ that the flap 135 has in the extended position upon being actuated by the flow of the air 20.

In the cross-sectional view of FIG. 8E, the deformable valve 25 is positioned adjacent to each of the rigid body first frame 90 and the rigid body second frame 105. The flap 135 of the deformable valve 25 comprises a thickness sufficient to permit extension of the flap 135 away from the base 120 due to application of a force caused by the flow of the air 20 against the flap 135. As such, the flap 135 may return to its original position, which is planar to the base 120 and covering the third opening 125 once the flow of the air 20 has stopped. Accordingly, the flap 135 has a material stiffness characteristic suitable to allow the flap 135 to articulate away from the base 120 when the flow of air 20 occurs, and to rest against the base 120 and covering the third opening 125 when the flow of air 20 stops. The third size 130 of the third opening 125 and the flap 135 permits a complete covering of the third opening 125 by the flap 135 when the flow of air 20 stops. However, the third size 130 of the third opening 125 of the flap 135 depicted in FIG. 8E is not shown in its fully enlarged position due to the flap 135 being depicted as not in a fully open position. Moreover, a uniform thickness of the base 120 and flap 135 permits the flap 135 to completely cover the third opening 125 when the flow of air 20 stops, according to an example.

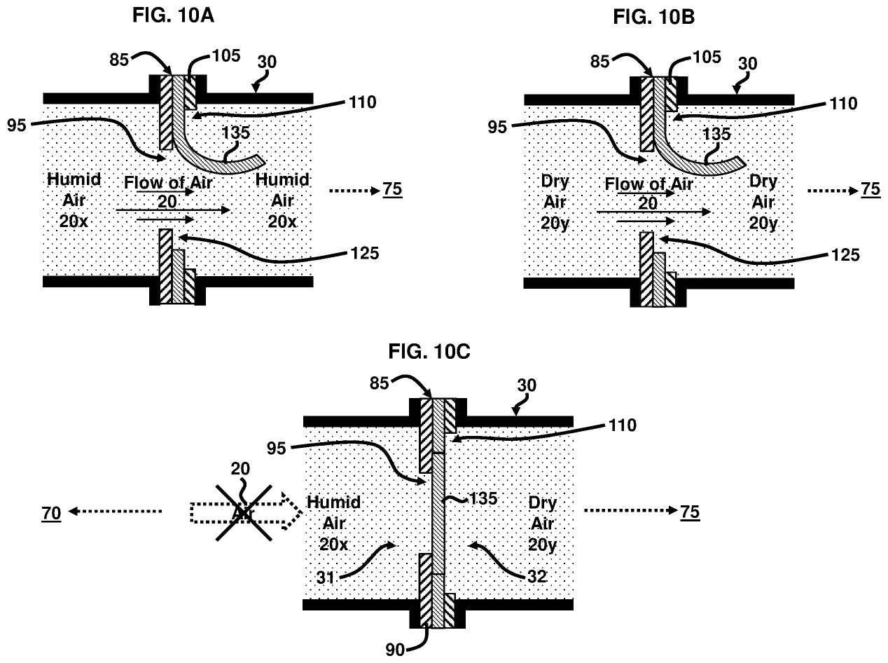

FIG. 9A, with reference to FIGS. 1 through 8E, illustrates a first side 31 of the valve assembly 85 with the deformable valve 25 positioned adjacent to the rigid body first frame 90 and the rigid body second frame 105. The first side 31 may be an inlet side of the valve assembly 85 with respect to the flow of air 20, in an example. In the view of FIG. 9A, the rigid body second frame 105 is not visible. FIG. 9B, with reference to FIGS. 1 through 9A, illustrates a second side 32 of the valve assembly 85 with the deformable valve 25 positioned adjacent to the rigid body first frame 90 and the rigid body second frame 105. The second side 32 may be an outlet side of the valve assembly 85 with respect to the flow of air 20, in an example. In the view of FIG. 9B, the rigid body first frame 90 is not readily visible, although the cut in the base 120 as provided by the third opening 125 may provide a slight view of the rigid body first frame 90. However, in order to not obscure the various components shown in FIG. 9B, the rigid body first frame 90 is not shown in FIG. 9B.

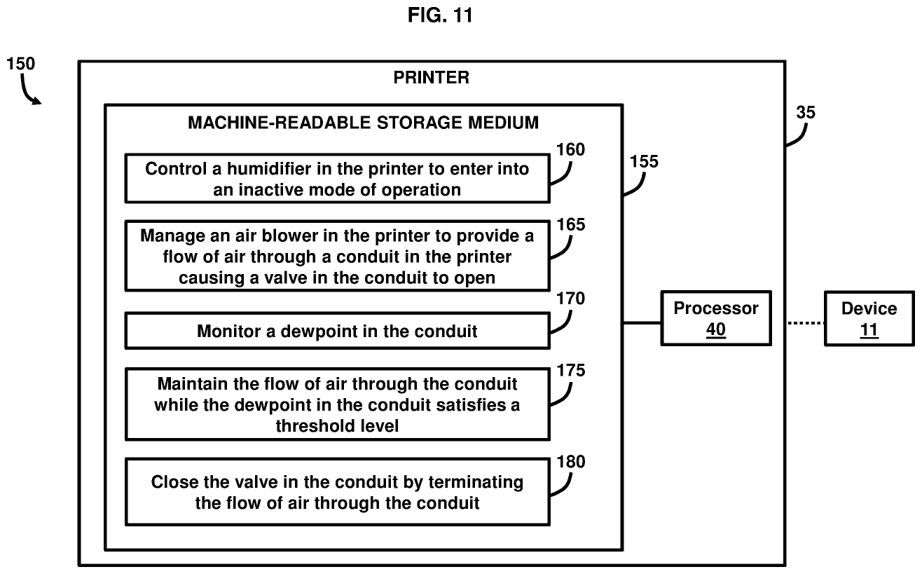

FIG. 10A, with reference to FIGS. 1 through 9B, illustrates that the flow of air 20 in the conduit 30 is to cause the flap 135 to extend through the second opening 110 of the rigid body second frame 105 to permit the flow of air 20 to move towards the build material reservoir 75, according to an example. In this regard, the extension of the flap 135 allows the flow of air 20 to go through the aligned first opening 95, the second opening 110, and the third opening 125. In the example shown in FIG. 10A, the entire conduit 30 contains humid air 20x since the flap 135 is open allowing the flow of air 20 to continue to pass through the valve assembly 85.

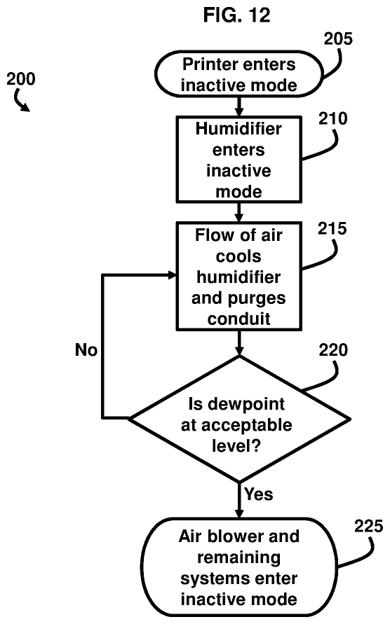

FIG. 10B, with reference to FIGS. 1 through 10A, illustrates that the flow of air 20 in the conduit 30 just prior to the air source 80 being switched to an inactive mode of operation. However, in FIG. 10B, the humidity source 70 enters into an inactive mode of operation and causes dry air 20y to be present in the conduit 30. This allows the air in the entire conduit 30 to become dried. FIG. 100, with reference to FIGS. 1 through 10B, illustrates that a discontinuing of the flow of air 20 in the conduit 30 is to cause the flap 135 to align with the third opening 125 and to cover the first opening 95 of the rigid body first frame 90. Accordingly, when the flow of air 20 ceases, then the flap 135 no longer extends outward and thus covers the third opening 125. In this position, the flap 135 acts as a non-permeable barrier of the air 20x, 20y on either side of the flap 135. In this regard, the air 20x, 20y may have dissimilar thermal and/or humidity characteristics, and the flap 135 regulates these different characteristics in the air 20x, 20y when the flap 135 covers the third opening 125. For example, humid air 20x may be on the first side 31 of the valve assembly 85, and dry air 20y may be on the second side 32 of the valve assembly 85 due to the air 20y being generally dried, as denoted in FIG. 10B, and remaining dry towards the build material reservoir 75. However, due to the air source 80 becoming deactivated, this causes the humidity to begin to rise in the humidity source 70, with the air 20x remaining humid towards the humidity source 70 and the flap 135 sealing the humid air 20x on the first side 31 in the conduit 30 while keeping the dry air 20y on the second side 32 in the conduit 30. While the flow of the air 20 stops to allow the flap 135 to cover the third opening 125, there still remains air 20x, 20y in the conduit 30; i.e., on either the first side 31 or second side 32 of the flap 135. However, the air 20x, 20y has substantially no flow rate.

Accordingly, covering of the first opening 95 by the flap 135 permits the flap 135 to regulate a first humidity level in the conduit 30 towards the humidity source 70; e.g., in first side 31. Moreover, covering of the first opening 95 by the flap 135 permits the flap 135 to regulate the second humidity level in the conduit 30 towards the build material reservoir 75; e.g., in second side 32. According to an example, the first humidity level is greater than the second humidity level.

FIG. 11, with reference to FIGS. 1 through 10C, illustrates an example system 150 to manage operation of a printer 35. In the example of FIG. 11, the printer 35 includes the processor 40 and a machine-readable storage medium 155. Processor 40 may include a central processing unit, microprocessors, hardware engines, and/or other hardware devices suitable for retrieval and execution of instructions stored in a machine-readable storage medium 155. Processor 40 may fetch, decode, and execute computer-executable instructions 160, 165, 170, 175, and 180 to enable execution of locally-hosted or remotely-hosted applications for controlling action of the printer 35. The remotely-hosted applications may be accessible on remotely-located devices; for example, communication device 11. For example, the communication device 11 may be a computer, tablet device, smartphone, or remote server. As an alternative or in addition to retrieving and executing instructions, processor 40 may include electronic circuits including a number of electronic components for performing the functionality of the instructions 160, 165, 170, 175, and 180.

The machine-readable storage medium 155 may be any electronic, magnetic, optical, or other physical storage device that stores executable instructions. Thus, the machine-readable storage medium 155 may be, for example, Random Access Memory, an Electrically-Erasable Programmable Read-Only Memory, volatile memory, non-volatile memory, flash memory, a storage drive (e.g., a hard drive), a solid-state drive, optical drive, any type of storage disc (e.g., a compact disc, a DVD, etc.), and the like, or a combination thereof. In one example, the machine-readable storage medium 155 may include a non-transitory computer-readable storage medium. The machine-readable storage medium 155 may be encoded with executable instructions for enabling execution of remotely-hosted applications accessed on the remotely-located devices 11.

In an example, the processor 40 of the printer 35 executes the computer-executable instructions 160, 165, 170, 175, and 180. For example, controlling instructions 160 may control a humidifier 50 in the printer 35 to enter into an inactive mode of operation. The controlling of the humidifier 50 may also alter the temperature in the printer 35. Furthermore, the controlling of the humidifier 50 may also switch other components and operations in the printer to enter into the inactive mode of operation. The operation of an air blower 15 or air source 80 may remain active, according to an example. Managing instructions 165 may manage the air blower 15 or air source 80 in the printer 35 to provide a flow of air 20 through a conduit 30 in the printer 35 causing a valve 25 in the conduit 30 to open. The flow rate of the air 20 may be selected at any suitable rate and it may be selected to be steady or variable. Monitoring instructions 170 may monitor a dewpoint in the conduit 30. The dewpoint may be monitored using sensor 65 to measure a temperature and relative humidity in the region 45 of the conduit 30 adjacent to the humidifier 50, in which the dewpoint is calculated from the measured temperature and relative humidity. Maintaining instructions 175 may maintain the flow of air 20 through the conduit 30 while the dewpoint in the conduit 30 satisfies a threshold level. The threshold level may be selected based on various factors including the size of the printer 35, conduit 30, or flow rate of the air 20, among other factors. In an example, the threshold level of the dewpoint may be approximately 25° C. Closing instructions 180 may close the valve 25 in the conduit 30 by terminating the flow of air 20 through the conduit 30. The valve 25 may be a passive device, which is actuated by the flow of air 20 through the conduit 30 without requiring any other type of actuation force. Accordingly, the flow of air 20 opens the valve 25, and the termination of the flow of air 20 closes the valve 25.

The computer-executable instructions 160, 165, 170, 175, and 180, when executed, further cause the processor 40 to regulate a humidity level in the printer 35 based on the flow of air 20 through the conduit 30. In this regard, the flow of air 20 may cool the printer 35 and associated systems such as the build material reservoir 75. Additionally, the computer-executable instructions 160, 165, 170, 175, and 180, when executed, further cause the processor 40 to switch the air blower 15 to enter into an inactive mode of operation upon the dewpoint in the conduit 30 no longer satisfying the threshold level. For example, once the dewpoint in the region 45 of the conduit 30 adjacent to the humidifier 50 reaches the threshold level, then the air blower 15 enters an inactive mode of operation, which terminates the flow of air 20 in the conduit 30. Accordingly, at this point, other components and systems of the printer 35 enter the inactive mode of operation.

According to some examples described herein, one-way valves 25, such as flapper valves, etc., are installed on the humidifier water bath air inlets (e.g., first side 31) and outlets (e.g., second side 32) to isolate the humidifier 50 from the rest of the system. An example valve assembly 85 may include a rigid body first frame 90 and a rigid body second frame 105 that provide a sealing surface for a deformable valve 25 allowing the valve 25 to be uni-directional. The flap 135, which may be flexible provides additional support for the valve assembly 85 and controls the flow of air 20 in the conduit 30.

Upon the printer 35 beginning to enter into an inactive mode of operation, the water heaters are turned off but the air blower 15 remains on to push or pull air through the water bath. This air cools the water and lowers the dewpoint in the water bath. This reduced dewpoint air flows through the conduit 30 and dries the printer 35 out to a safe threshold. Once the humidity reaches an acceptable level the air blower 15 enters the inactive mode of operation. As such, the valve assembly 85 in conjunction with a drying monitoring process constrains condensation to the humidifier 50 where it poses no issues to the printer 35. This prevents condensation from forming anywhere else in the printer 35.

FIG. 12, with reference to FIGS. 1 through 11, is a flow diagram illustrating the drying monitoring process 200 by controlling the flow of air in the printer 35, according to an example. First, in block 205, the printer 35 enters an inactive mode of operation. The air blower 15 may remain active. In an example, the processor 40 may also remain active and may control the switching of the modes of operation of the printer 35. Next, in block 210, the humidifier 50 in the printer 35 enters the inactive mode of operation. The humidifier 50 may be a water heater, in an example. Again, in an example, the processor 40 may control the switching of the humidifier 50 in the printer 35 to enter into the inactive mode of operation. Then, in block 215, the flow of air 20 is used to cool the humidifier 50 in the printer 35 and is further used to purge; i.e., cool and dry, the conduit 30 as the flow of air 20 proceeds towards the build material reservoir 75. In this regard, the flow of air 20 pushing against the deformable valve 25 causes the flap 135 to outwardly extend thereby permitting the air 20 to flow through the valve assembly 85 in the conduit 30. After this, in block 220, the processor 40 determines whether the calculated dewpoint in the conduit 30 in the region 45 adjacent to the build material reservoir 75 is at an acceptable level based on a programmed threshold level processed by the processor 40. If the calculated dewpoint is not at an acceptable level, then the process 200 continues with the flow of air 20 in the conduit 30 as indicated in block 215. However, if the calculated dewpoint is at an acceptable level, then the process 200 moves to block 225, in which the air blower 15 and the other systems in the printer 35 enters the inactive mode of operation, which concludes the drying monitoring process 200.

The examples described above is able to isolates humidity sources within a printer 35 and achieves low pressure drops using the uni-directional valve 25 by ensuring the flow of air 20 in one direction in the conduit 30. Because the valve 25 is passive, according to an example, it uses no power, which reduces the cost and complexity of the printer 35. Moreover, the techniques described herein protect potentially vulnerable components from corrosion by isolating the humidity sources in the printer 35. Furthermore, the examples described prevents condensation from occurring in vulnerable areas of the printer 35, which permits reliable use of inexpensive capacitive humidity sensors in high humidity environments and protects sensors from drift when the printer 35 is not in use. Additionally, the example techniques described above prevent condensation from forming and degrading build material in the printer 35.

The present disclosure has been shown and described with reference to the foregoing implementations. Although specific examples have been illustrated and described herein it is manifestly intended that other forms, details, and examples may be made without departing from the scope of the disclosure that is defined in the following claims.

What is claimed is:

1. A system comprising:
an air blower to provide a flow of air;
a valve to control the flow of air through a conduit of a printer; and
a processor to:
maintain the flow of air through the conduit while the printer enters an inactive mode of operation, wherein the air blower remains in an active mode of operation, and wherein the flow of air is to open the valve;
calculate a dewpoint in a region of the conduit adjacent to a humidifier; and
discontinue the flow of air from the air blower upon determining that the calculated dewpoint satisfies a threshold dewpoint level.

2. The system of claim 1, wherein the printer comprises a three-dimensional (3D) printer.

3. The system of claim 1, wherein the valve comprises a uni-directional passive valve.

4. The system of claim 1, comprising a sensor to measure a temperature and relative humidity in the region of the conduit adjacent to the humidifier, wherein the processor is to calculate the dewpoint based on the temperature and relative humidity measured by the sensor.

5. The system of claim 1, wherein the processor is to switch the air blower to the inactive mode of operation upon discontinuing the flow of air.

6. The system of claim 1, wherein a discontinuing of the flow of air from the air blower causes the valve to close.

7. A three-dimensional (3D) printer comprising:
a humidity source;
a build material reservoir;
a conduit between the humidity source and the build material reservoir;
an air source to transfer air from the humidity source through the conduit towards the build material reservoir; and
a valve assembly connected to the conduit to control a flow of the air in the conduit while the 3D printer enters an inactive mode of operation, wherein the air source remains in an active mode of operation,
wherein the air source is controlled to transmit the air in the conduit until the air in the conduit adjacent to the build material reservoir reaches a temperature and relative humidity threshold.

8. The 3D printer of claim 7, wherein the valve assembly comprises:
a rigid body first frame comprising a first opening having a first size;
a rigid body second frame comprising a second opening having a second size larger than the first size; and
a deformable valve positioned between the rigid body first frame and the rigid body second frame.

9. The 3D printer of claim 8, wherein the deformable valve comprises:
a base comprising a third opening having a third size larger than the first size and smaller than the second size; and
a flap extending from the base and comprising the third size,
wherein the first opening, the second opening, and the third opening are positioned normal to the flow of air in the conduit.

10. The 3D printer of claim 9, wherein the flow of air in the conduit is to cause the flap to extend through the second opening of the rigid body second frame to permit the flow of air to move towards the build material reservoir.

11. The 3D printer of claim 9, wherein a discontinuing of the flow of air in the conduit is to cause the flap to align with the third opening and to cover the first opening of the rigid body first frame.

12. The 3D printer of claim 11, wherein covering of the first opening by the flap is to regulate a first humidity level in the conduit towards the humidity source and a second humidity level in the conduit towards the build material reservoir, and wherein the first humidity level is greater than the second humidity level.

13. A machine-readable storage medium comprising computer-executable instructions that when executed cause a processor of a printer to:
control a humidifier in the printer to enter into an inactive mode operation;
manage an air blower in the printer to provide a flow of air through a conduit in the printer causing a valve in the conduit to open;
monitor a dewpoint in the conduit;
maintain the flow of air through the conduit while the dewpoint in the conduit satisfies a threshold level; and
close the valve in the conduit by terminating the flow of air through the conduit.

14. The machine-readable storage medium of claim 13, wherein the instructions, when executed, further cause the processor to regulate a humidity level in the printer based on the flow of air through the conduit.

15. The machine-readable storage medium of claim 13, wherein the instructions, when executed, further cause the processor to switch the air blower into the inactive mode of operation upon the dewpoint in the conduit no longer satisfying the threshold level.
